(19) United States
(12) Patent Application Publication
(10) Pub. No.: US 2013/0168312 A1
(43) Pub. Date: Jul. 4, 2013

(54) FILTERATION MATERIAL FOR DESALINATION

(71) Applicants: Nai-Jung Chen, Kaohsiung City (TW); Kuei-Chien Chang, Zhongli City (TW); Shu-Hui Cheng, Hsinchu County (TW); Wei-Cheng Tsai, Taipei City (TW)

(72) Inventors: Nai-Jung Chen, Kaohsiung City (TW); Kuei-Chien Chang, Zhongli City (TW); Shu-Hui Cheng, Hsinchu County (TW); Wei-Cheng Tsai, Taipei City (TW)

(21) Appl. No.: 13/472,127

(22) Filed: May 15, 2012

(30) Foreign Application Priority Data
Dec. 28, 2011 (TW) 100149118

(51) Int. Cl. B01D 39/00; B82Y 30/00

(52) U.S. Cl. 210/508; 977/902

(57) ABSTRACT

The disclosure discloses a filtration material for desalination, including: a support layer; a nanofiber layer formed on the support layer; a hydrophobic layer formed on the nanofiber layer; and a hydrophilic layer formed on the hydrophobic layer. The nanofiber layer includes ionic polymer, polyvinyl alcohol (PVA), polyacrylonitrile, (PAN), polyethersulfone (PES) or polyvinglidene fluoride (PVDF). The hydrophobic layer includes polypropylene (PP), polyvinglidene fluoride (PVDF), poly-dimethylsiloxane (PDMS) or epoxy.

### CROSS REFERENCE TO RELATED APPLICATIONS

This application claims priority of Taiwan Patent Application No. 100149118, filed on Dec. 28, 2011, the entirety of which is incorporated by reference herein.

### TECHNICAL FIELD

The present disclosure relates to a filtration material for desalination, and in particular relates to a filtration material for desalination having multi-layers.

### BACKGROUND

Recently, filtration materials for desalination are being used for application with sea water, industrial water and wastewater. Some main goals for practitioners are for efficient salt water treatment, the reduction of operating pressure, low energy consumption, and reduced water treatment costs.

U.S. Pat. No. 5,464,538 discloses a filtration material made of a cross-linked polyethylene. The filtration material exhibits a high flux.

U.S. Pat. No. 5,755,964 discloses a reverse osmosis (RO) membrane, wherein the RO membrane has good wetting property and high flux by using an amine compound to treat the surface of the RO membrane.

The filtration materials for desalination in the prior art are mainly made of nonporous polymeric thin film. However, the nonporous polymeric thin film must be operated under a higher pressure.

Accordingly, there is a need to develop a filtration material for desalination which is operated under a relatively lower pressure, while having high desalination efficiency.

### SUMMARY

The present disclosure provides a filtration material for desalination, comprising: a support layer; a nanofiber layer formed on the support layer; a hydrophobic layer formed on the nanofiber layer; and a hydrophilic layer formed on the hydrophobic layer.

A detailed description is given in the following embodiments with reference to the accompanying drawings.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows a cross-sectional schematic representation of a filtration material for desalination in accordance with an embodiment of the disclosure;

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

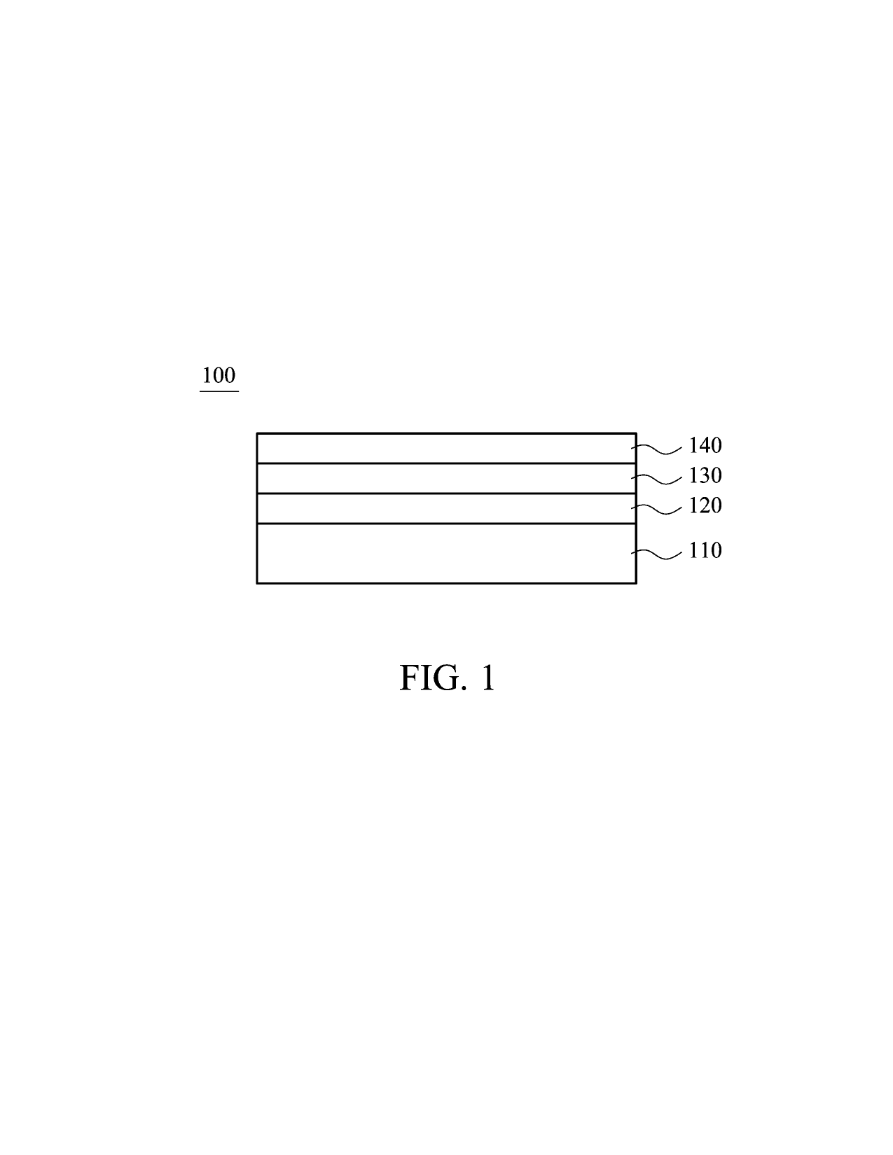

Referring to FIG. 1, the disclosure provides a filtration material 100 for desalination, wherein a nanofiber layer 120, a hydrophilic layer 130 and a hydrophobic layer 140 are sequentially formed on a support layer 110.

The support layer 110 comprises a one layer porous material or multi-layered porous materials. The porous materials comprise cellouse ester, polysulfone, polyacrylonitrile (PAN), polyvinglidene fluoride (PVDF), polyetheretherketone (PEK), polyester (PET), polyimide (PI), chlorinated polyvinyl chloride (PVC) or styrene acrylnitrile (SAN). The support layer 110 may be self-made or commercially available and may be in form of non-woven, woven or open pores.

The nanofiber layer 120 comprises ionic polymer, polyvinyl alcohol (PVA), polyacrylonitrile, (PAN), Polyethersulfone (PES) or polyvinglidene fluoride (PVDF).

The ionic polymer has the following formula (I):

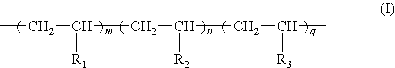

wherein R₁ comprises phenyl sulfonate or alkyl sulfonate; R₂ comprises

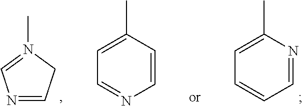

R₃ comprises

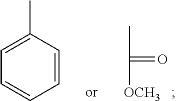

and m, n and q are the number of repeating units and independently comprises 1-200. The average molecular weight of the ionic polymer is about 5000-160000. The m, n and q are obtained by a theoretical calculation.

The nanofiber layer 120 is formed by a solution spinning method or electrospinning method. Additionally, the nanofiber layer 120 has a diameter of about 20-600 nm, and preferably 50-200 nm.

Furthermore, in order to improve the mechanical strength of the nanofiber layer 120, the ionic polymer further reacts with a cross-linker to conduct a cross-linking reaction. The cross-linker is cross-linked to the hydrophilic or hydrophobic groups of the ionic polymer (preferably to react with the hydrophilic groups) to reduce the solubility of the ionic polymer. The cross-linker comprises acid anhydride, epoxy, isocyanate, aminoplast resins (the product of formaldehyde reacting with melamine, urea or guanamine), carbodiimide, aziridine or derivatives thereof.

The hydrophobic layer 130 comprises polypropylene (PP), polyvinglidene fluoride (PVDF), poly-dimethylsiloxane (PDMS) or epoxy.

The hydrophobic layer 130 is formed by an interfacial polymerization (IP) process or coating process. The thickness of the hydrophobic layer 130 is about 50-1000 nm, and preferably 100-300 nm. The interfacial polymerization (IP) process is a polycondensation reaction wherein the monomers are dissolved in two mutually immiscible solvents, and a dense film is formed in the interface between the two immiscible solvents.

In one embodiment, the hydrophobic layer 130 is a polyamide film which is formed by reacting the amine compounds and acid chloride compounds together. Firstly, the amine compounds are dissolved in an alcohol-like solvent and water to form an amine solution. Then, a composite material (including the support layer 110 and the nanofiber layer 120) is immersed into the amine solution. Next, the composite material is removed from the amine solution and dried to remove the excess water. The composite material is then placed in a solvent containing the acid chloride compounds to proceed with the interfacial polymerization (IP) process to form the hydrophobic layer 130.

The amine compounds comprise about 0.1-30 weight percent of the amine solution. The amine compounds comprise piperazine (PIP) or m-phenylene diamine (MPD). The alcohol-like solvent comprises methanol, ethanol, isopropane or n-butanol.

The acid chloride compounds comprise about 0.1-1 weight percent of the solvent. The acid chloride compounds comprise trimesoyl chloride (TMC) or telephthalloyl chloride (TPC). The solvent comprises hexane, 1,1,2-trichloro-1,2,2-trifluoroethane, pentane or heptane.

The coating process comprises spin coating, brush coating, knife coating, spraying, dip coating, slot die coating or printing. During the coating process, a hydrophobic material comprises about 1-10 weight percent of a coating solution.

The hydrophilic layer 140 comprises ionic polymer or polyvinyl alcohol (PVA). In order to improve the mechanical strength of the hydrophilic layer 140, the hydrophilic layer 140 further reacts with a cross-linker to conduct a cross-linking reaction. In one embodiment, the ionic polymer reacts with the cross-linker (such as epoxy or alkyl halides) which comprises 10-30 weight percent of the ionic polymer. In another embodiment, the polyvinyl alcohol (PVA) reacts with the cross-linker (such as propanediol, maleic acid or maleic acid anhydrides) which comprises 1-10 weight percent of the polyvinyl alcohol (PVA).

In the prior art, the filtration material for desalination mainly comprises a supporting layer, a porous layer and a surface activation layer. The porous layer has the finger-like structure (pore size of about 0.01-1 μm), the surface activation layer is dense and almost has no pores, and thus the conventional filtration material must be operated under a high pressure to maintain a high water flux.

Note that the filtration material for desalination of the disclosure has a composite layer (or multi-layers) to achieve high water flux and high desalination efficiency. The upper hydrophilic layer 140 has a high affinity to water. Additionally, the upper hydrophilic layer 140 has an ionic property to form an electrostatic reaction with the salts in water to repel the ions in the water. The middle hydrophobic layer 130 forms a channel with no resistance to allow water to quickly flow through the hydrophobic layer 130. The nanofiber layer 120 has a network porous structure (having a higher porous membrane porosity than the conventional porous film) to improve water flux. An interfacial capillary driving force is formed between the nanofiber layer 120 and the hydrophobic layer 130 and another capillary driving force is formed between the hydrophobic layer 130 and the hydrophilic layer 140 to accelerate the diffusion of the water and provide a downward force. The water will pass through the multi-layers quickly to achieve high water flux and high desalination efficiency.

The conventional reverse osmosis (RO) membranes have smaller pores (smaller than 1 nm). Thus, the membranes must be operated under a pressure which is larger than about 500 psi, even 1000 psi. The main advantage of the disclosure is that the filtration material can exhibit a high water flux as with the conventional RO membrane, but may be operated under a lower pressure environment. The water flux of the filtration material of the disclosure is larger than 5 ml/hr, and the desalination efficiency is about 95%-99% under a trans-membrane pressure (TMP) of smaller than 5 kg/cm².

The filtration material for desalination of the disclosure may be additionally combined with other conventional permeable, semi-permeable membranes or other polymer films according to actual applications.

Because the filtration material of the disclosure has multi-layers, and each layer has, individually, a specific function, the filtration material still has high water flux even if operated under low pressure. The filtration material of the disclosure may be used in a desalination process, wastewater treatment, ultrapure water treatment, water softening or heavy metals recovery

### FABRICATION EXAMPLE

### Fabrication Example 1

### Fabrication of PAN Nanofiber Layer

30 g of polyacrylonitrile (PAN) was dissolved in 200 g of N,N-dimethyl-acetamide (DMAc) to provide a spinning solution. The PAN nanofiber layer was obtained by an electrospinning method with an applied voltage of 39 KV, a spray amount of 1000 μL/min, a 25 cm distance between the collector and spinneret, and an air pressure of 2.8 kg/cm³. A nanofiber layer with a diameter of 280 nm-380 nm and weight of 30-60 g/m² was obtained.

### Fabrication Example 2

### Fabrication of the Ionic Polymer Nanofiber Layer (the Ionic Polymer is Referred to as polyE)

10 g of sodium styrenesulfate, 40 g of 4-vinyl pyridine, 7 g of styrene, 50 g of deionized water and 50 g of isopropanol (IPA) were dissolved in a reaction flask, and stirred under N₂ atmosphere at 70° C. A solution containing 0.2 g of potassium persulfate (KPS) in 10 mL of the deionized water was slowly added into the reaction flask, and kept for 3 hours. The mixture was purified to obtain 50.1 g of the ionic polymer (polyE) (88%).

Then, the ionic polymer (polyE) was dissolved in 200 g of N,N-dimethyl-acetamide (DMAc) to provide a spinning solution. The ionic polymer nanofiber layer was obtained by an electrospinning method with an applied voltage of 39 KV, a spray amount of 1200 μL/min, a 20 cm distance between the collector and spinneret, and an air pressure of 5 kg/cm³. An ionic polymer nanofiber layer with a diameter of 70 nm-120 nm and weight of 60-94 g/m² was obtained. The average molecular weight of the ionic polymer (polyE) is about 136784.

### EXAMPLE

### Example 1

An aqueous phase was formed by mixing m-phenylene diamine (MPD) and water with a weight ratio of 2:98. An organic phase was formed by mixing trimesoyl chloride (TMC) and hexane with a weight ratio of 0.1:100.

The PAN nanofiber layer of Fabrication Example 1/PET support layer was placed in the aqueous phase for 3 minutes. The excess water was removed from the PAN nanofiber layer/PET support layer. The PAN nanofiber layer/PET support layer was placed in an organic phase for 30 seconds, and then placed in an oven at 70° C. for 10 minutes to form a three-layered composite layer (a hydrophobic layer formed on the PAN nanofiber layer/PET support layer).

The poly E of Fabrication Example 2 was dissolved in ethanol (5 wt %) to form a coating solution. The three-layered layer was coated with the coating solution and then put in an oven at 70° C. for 20 minutes to form the filtration material. A desalination test was conducted under 30000 ppm of sodium chloride (NaCl) to test the desalination efficiency of the filtration material of Example 1.

### Example 2

The poly E of Fabrication Example 2 was dissolved in ethanol (5 wt %) to form a coating solution. The polyE nanofiber layer/PET support layer was coated with the coating solution and then put in an oven at 70° C. for 20 minutes to form a three-layered composite layer.

Then, the three-layered composite layer was placed in an aqueous phase (MPD/water with a weight ration of 2/98) for 3 minutes. The three-layered composite layer was removed and the excess water was removed. The three-layered composite layer was placed in an organic phase (TMC/hexane with a weight ration of 0.1/1000) for 30 seconds, and then placed in an oven at 70° C. for 10 minutes to form a filtration material. A desalination test was conducted under 30000 ppm of sodium chloride (NaCl) to test the desalination efficiency of the filtration material of Example 2.

### Example 3

The poly E of Fabrication Example 2/PET support layer was placed in an aqueous phase (MPD/water with a weight ration of 2/98) for 3 minutes. The poly E of Fabrication Example 2/PET support layer was removed and the excess water was removed. The poly E of Fabrication Example 2/PET support layer was placed in an organic phase (TMC/hexane with a weight ration of 0.1/1000) for 30 seconds, and then placed in an oven at 70° C. for 10 minutes to form a three-layered composite layer (a hydrophobic layer formed on the poly E of Fabrication Example 2/PET support layer).

The polyvinyl alcohol (PVA) was dissolved in water to form a 5 wt % polyvinyl alcohol (PVA) solution, and then 0.1 wt % of glutaraldehyde (GA) was added into the polyvinyl alcohol (PVA) solution to form a coating solution. The three-layered layer was coated with the coating solution and then put in an oven at 70° C. for 20 minutes to form the filtration material. A desalination test was conducted under 400 ppm of calcium chloride (CaCl₂) to test the desalination efficiency of the filtration material of Example 3.

### Example 4

The poly E of Fabrication Example 2/PET support layer was placed in an aqueous phase ((piperazine, PIP)/water with a weight ration of 2/98) for 3 minutes. The poly E of Fabrication Example 2/PET support layer was removed and the excess water was removed. The poly E of Fabrication Example 2/PET support layer was placed in an organic phase (TMC/hexane with a weight ration of 0.1/1000) for 30 seconds, and then placed in an oven at 70° C. for 10 minutes to form a three-layered composite layer (a hydrophobic layer formed on the poly E of Fabrication Example 2/PET support layer).

The poly E of Fabrication Example 2 was dissolved in ethanol (5 wt %) to form a coating solution. The three-layered layer was coated with the coating solution and then put in an oven at 70° C. for 20 minutes to form the filtration material. A desalination test was conducted under 30000 ppm of sodium chloride (NaCl) to test the desalination efficiency of the filtration material of Example 4.

### Example 5

The poly E of Fabrication Example 2/PET support layer was placed in an aqueous phase (PIP/water with a weight ration of 2/98) for 3 minutes. The poly E of Fabrication Example 2/PET support layer was removed and the excess water was removed. The poly E of Fabrication Example 2/PET support layer was placed in an organic phase (TMC/hexane with a weight ration of 0.1/1000) for 30 seconds, and then placed in an oven at 70° C. for 10 minutes to form a filtration material. A desalination test was conducted under 400 ppm of calcium chloride (CaCl₂) to test the desalination efficiency of the filtration material of Example 5.

### Example 6

The poly E of Fabrication Example 2/PET support layer was placed in an aqueous phase (MPD/water with a weight ration of 2/98) for 3 minutes. The poly E of Fabrication Example 2/PET support layer was removed and the excess water was removed. The poly E of Fabrication Example 2/PET support layer was placed in an organic phase (TMC/hexane with a weight ration of 0.1/1000) for 30 seconds, and then placed in an oven at 70° C. for 10 minutes to form a filtration material. A desalination test was conducted under 400 ppm of calcium chloride (CaCl₂) to test the desalination efficiency of the filtration material of Example 6.

### Example 7

The poly E of Fabrication Example 2/PET support layer was coated with a 5 wt % of polypropylene solution and then put in an oven at 70° C. for 20 minutes to form a three-layered layer.

The poly E of Fabrication Example 2 was dissolved in ethanol (5 wt %) to form a coating solution. The three-layered layer was coated with the coating solution and then put in an oven at 70° C. for 10 minutes to form a filtration material. A desalination test was conducted under 400 ppm of calcium chloride (CaCl₂) to test the desalination efficiency of the filtration material of Example 7.

### Example 8

The polyvinglidene fluoride (PVDF) was dissolved in an acetone solution (5 wt %) to form a coating solution. The poly E of Fabrication Example 2/PET support layer was coated with the coating solution by a spraying method and then put in an oven at 70° C. for 20 minutes to form a three-layered material.

Then, the poly E of Fabrication Example 2 was dissolved in ethanol (5 wt %) to form a coating solution. The three-layered material was coated with the coating solution and then put in an oven at 70° C. for 10 minutes to form a filtration material. A desalination test was conducted under 400 ppm of calcium chloride (CaCl₂) to test the desalination efficiency of the filtration material of Example 8.

### Example 9

The poly E of Fabrication Example 2/PET support layer was coated with a 5 wt % of poly-dimethylsiloxane (PDMS) solution and then put in an oven at 70° C. for 20 minutes to form a three-layered material.

Then, the poly E of Fabrication Example 2 was dissolved in ethanol (5 wt %) to form a coating solution. The three-layered material was coated with the coating solution and then put in an oven at 70° C. for 10 minutes to form a filtration material. A desalination test was conducted under 400 ppm of calcium chloride (CaCl₂) to test the desalination efficiency of the filtration material of Example 9.

### Example 10

The 0.1 wt % of diethylene triamine (DETA) was added into the epoxy solution (5%) to form a coating solution. The poly E of Fabrication Example 2/PET support layer was coated with the coating solution and then put in an oven at 70° C. for 20 minutes to form a three-layered material.

Then, the poly E of Fabrication Example 2 was dissolved in ethanol (5 wt %) to form a second coating solution. The three-layered material was coated with the second coating solution and then put in an oven at 70° C. for 10 minutes to form a filtration material. A desalination test was conducted under 400 ppm of calcium chloride (CaCl₂) to test the desalination efficiency of the filtration material of Example 10.

### Comparative Example 1

The PES porous film was placed in an aqueous phase (MPD/water with a weight ration of 2/98) for 3 minutes. The PES porous film was removed and the excess water was removed. The PES porous film was placed in an organic phase (TMC/hexane with a weight ration of 0.1/1000) for 30 seconds, and then placed in an oven at 70° C. for 10 minutes to form a filtration material. A desalination test was conducted under 30000 ppm of sodium chloride (NaCl) to test the desalination efficiency of the filtration material of Comparative Example 1.

### Comparative Example 2

The PAN nanofiber of the Fabrication Example 1/PET support layer was placed in an aqueous phase (MPD/water with a weight ration of 2/98) for 3 minutes. The PAN nanofiber of the Fabrication Example 1/PET support layer was removed and the excess water was removed. The PAN nanofiber of the Fabrication Example 1/PET support layer was placed in an organic phase (TMC/hexane with a weight ration of 0.1/1000) for 30 seconds, and then placed in an oven at 70° C. for 10 minutes to form a filtration material. A desalination test was conducted under 30000 ppm of sodium chloride (NaCl) to test the desalination efficiency of the filtration material of Comparative Example 2.

### Comparative Example 3

The polyvinyl alcohol (PVA) was dissolved in water to form a 5 wt % polyvinyl alcohol (PVA) solution, and then 0.1 wt % of glutaraldehyde (GA) was added into the polyvinyl alcohol (PVA) solution to form a coating solution. A PES layer was coated with the coating solution and then put in an oven at 70° C. for 20 minutes to form the filtration material. A desalination test was conducted under 30000 ppm of sodium chloride (NaCl) to test the desalination efficiency of the filtration material of Comparative Example 3.

### Comparative Example 4

The 0.1 wt % of diethylene triamine (DETA) was added into the epoxy solution (5%) to form a coating solution. A PES layer was coated with the coating solution and then put in an oven at 70° C. for 20 minutes to form a three-layered material. A desalination test was conducted under 30000 ppm of sodium chloride (NaCl) to test the desalination efficiency of the filtration material of Comparative Example 4.

### Comparative Example 5

A PES layer was coated with a 5 wt % of silicon resin solution and then put in an oven at 70° C. for 20 minutes to form a filtration material. A desalination test was conducted under 30000 ppm of sodium chloride (NaCl) to test the desalination efficiency of the filtration material of Comparative Example 5.

### Comparative Example 6

The material of Comparative Example 6 is the same with that of Comparative Example 1. The difference is that the desalination test of Comparative Example 6 was conducted under 400 ppm of calcium chloride (CaCl₂).

The desalination efficiency of Examples 1-10 and Comparative Examples 1-5 are shown in Table 1. As shown in Table 1, the desalination efficiency (%) of Examples 1-2 and 4 for NaCl was about 97-99% under the trans-membrane pressure (TMP) of smaller than 5 kg/cm², and this data shows that the filtration material of the disclosure is promising for usage in the filtration of seawater. The Examples 3 and 5-10 was checked by a CaCl₂ desalination test and the data shows that the filtration material of the disclosure is promising for usage in water softening treatment.

Additionally, as shown in Table 1, the desalination efficiency (%) of Comparative Examples 1-5 can not be measured under the trans-membrane pressure (TMP) of smaller than 5 kg/cm², and the desalination efficiency (%) of Comparative Example 2 can not be measured because the filtration material of the Comparative Example 2 has no upper hydrophilic layer.

TABLE 1

| | | | | | | | desalination | | | |
|---|---|---|---|---|---|---|---|---|---|---|
| | Support | Porous | Nanofiber | Hydrophobic | Hydrophilic | flux | efficiency | TMP | CaCl₂ | NaCl |
| | layer | layer | layer | layer | layer | (mL/hr) | (%) | (kg/cm²) | (ppm) | (ppm) |
| Example | | | | | | | | | | |
| 1 | PET | none | PAN | MPD/TMC | PolyE | 6.5 | 97 | 5 | | 30000 |
| 2 | PET | none | PolyE | MPD/TMC | none | 2.5 | 97 | 5 | | 30000 |
| 3 | PET | none | PolyE | MPD/TMC | PVA | 5 | 99 | 5 | 400 | |
| 4 | PET | none | PolyE | PIP/TMC | PolyE | 8.7 | 97 | 5 | | 30000 |
| 5 | PET | none | PolyE | PIP/TMC | none | 84 | 90 | 5 | 400 | |
| 6 | PET | none | PolyE | MPD/TMC | none | 33 | 97 | 5 | 400 | |
| 7 | PET | none | PolyE | PP | PolyE | 20 | 98 | 5 | 400 | |
| 8 | PET | none | PolyE | PVDF | PolyE | 5.3 | 98 | 5 | 400 | |
| 9 | PET | none | PolyE | PDMS | PolyE | 4.8 | 98 | 5 | 400 | |
| 10 | PET | none | PolyE | Epoxy | PolyE | 6.1 | 98 | 5 | 400 | |
| Comparative | | | | | | | | | | |
| Example | | | | | | | | | | |
| 1 | PET | PES | none | MPD/TMC | none | x | x | 5 | | 30000 |
| 2 | PET | none | PAN | MPD/TMC | none | x | x | 5 | | 30000 |
| 3 | PET | PES | none | none | PVA | x | x | 5 | | 30000 |
| 4 | PET | PES | none | Epoxy | none | x | x | 5 | | 30000 |
| 5 | PET | PES | none | Silicon | none | x | x | 5 | | 30000 |
| | | | | resin | | | | | | |
| 6 | PET | PES | none | MPD/TMC | none | 1.2 | 99 | 5 | 400 | |

x: Can not be measured

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A filtration material for desalination, comprising:
a support layer;
a nanofiber layer formed on the support layer;
a hydrophobic layer formed on the nanofiber layer; and
a hydrophilic layer formed on the hydrophobic layer.

2. The filtration material for desalination as claimed in claim 1, wherein the support layer comprises a one layer porous material or multi-layered porous materials.

3. The filtration material for desalination as claimed in claim 2, wherein the porous materials comprise cellouse ester, polysulfone, polyacrylonitrile (PAN), polyvinglidene fluoride (PVDF), polyetheretherketone (PEK), polyester (PET), polyimide (PI), chlorinated polyvinyl chloride (PVC) or styrene acrylnitrile (SAN).

4. The filtration material for desalination as claimed in claim 1, wherein the nanofiber layer comprises ionic polymer, polyvinyl alcohol (PVA), polyacrylonitrile, (PAN), Polyethersulfone (PES) or polyvinglidene fluoride (PVDF).

5. The filtration material for desalination as claimed in claim 4, wherein the ionic polymer has the formula (I): 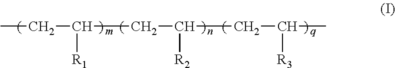
wherein R₁ comprises phenyl sulfonate or alkyl sulfonate;
R₂ comprises 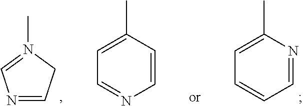
R₃ comprises 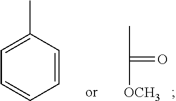
and
m, n and q are the number of repeating units and independently comprises 1-200.

6. The filtration material for desalination as claimed in claim 1, wherein the nanofiber layer is formed by a solution spinning method or electrospinning method.

7. The filtration material for desalination as claimed in claim 1, wherein the hydrophobic layer comprises polypropylene (PP), polyvinglidene fluoride (PVDF), poly-dimethylsiloxane (PDMS) or epoxy.

8. The filtration material for desalination as claimed in claim 1, wherein the hydrophobic layer is formed by a interfacial polymerization (IP) process or coating process.

9. The filtration material for desalination as claimed in claim 8, wherein the monomers are used in the interfacial polymerization (IP) process, and the monomers comprise amine compounds and acid chloride compounds.

10. The filtration material for desalination as claimed in claim 9, wherein the amine compounds comprise piperazine (PIP) or m-phenylene diamine (MPD).

11. The filtration material for desalination as claimed in claim 9, wherein the acid chloride compounds comprise trimesoyl chloride (TMC) or telephthalloyl chloride (TPC).

12. The filtration material for desalination as claimed in claim 8, wherein the coating process comprises spin coating, brush coating, knife coating, spraying, dip coating, slot die coating or printing.

13. The filtration material for desalination as claimed in claim 1, wherein the hydrophilic layer comprises ionic polymer or polyvinyl alcohol (PVA).

14. The filtration material for desalination as claimed in claim 13, wherein the ionic polymer is cross-linked to a first cross-linker, and the first cross-linker comprises epoxy or alkyl halides.

15. The filtration material for desalination as claimed in claim 13, wherein the polyvinyl alcohol (PVA) is cross-linked to a second cross-linker, and the second cross-linker comprises propanediol, maleic acid or maleic acid anhydrides.
